(19) United States
(12) Patent Application Publication
(10) Pub. No.: US 2026/0161292 A1
(43) Pub. Date: Jun. 11, 2026

(54) STORAGE DEVICE DETERMINING TRANSMISSION INTERVAL OF STATUS READ COMMAND AND METHOD FOR OPERATING THE SAME

(71) Applicant: SK hynix Inc., Icheon-si (KR)

(72) Inventors: Seung Gu JI, Icheon-si (KR); Hye Rim HYUN, Icheon-si (KR)

(21) Appl. No.: 19/187,789

(22) Filed: Apr. 23, 2025

(30) Foreign Application Priority Data
Dec. 9, 2024 (KR) 10-2024-0181149

(51) Int. Cl. G06F 3/06

(52) U.S. Cl. CPC G06F 3/0611; G06F 3/0659; G06F 3/0673

(57) ABSTRACT

A storage device may comprise a memory including a plurality of memory blocks and a cache and a controller transmitting a first read command requesting to cache first data to the cache to the memory when the memory is in an internal ready state, transmitting a data output command requesting to output the first data to the memory when the memory is in an external ready state after transmitting the first read command, determining whether a second read command requesting to cache second data is present after receiving the first data output, and determining a transmission interval of a target status read command, which is a status read command for identifying a processing result of the second read command, differently based on whether the memory is in an internal busy state or the internal ready state when the second read command is present.

### CROSS-REFERENCES TO RELATED APPLICATION

The present application claims priority under 35 U.S.C. 119(a) to Korean patent application number 10-2024-0181149 filed on Dec. 9, 2024, which is incorporated herein by reference in its entirety.

### BACKGROUND

### 1. Technical Field

Embodiments of the present disclosure relate to a storage device determining a transmission interval of status read commands and a method for operating the same.

### 2. Related Art

A storage device is a device for storing data according to a request from an external device such as a computer, a mobile terminal (e.g., a smart phone or tablet), or the like.

A storage device may include a memory for storing data therein and a controller for controlling the memory. The memory may be a volatile memory or a non-volatile memory. The controller may receive a command from an external device (i.e., a host), and execute or control operations to read, write, or erase data in the memory included in the storage device according to the received command.

After transmitting a command requesting an operation to read, write, or erase data in the memory, the controller may transmit a status read command to determine the processing result of the operation. However, this can introduce overhead while the memory processes the status read command.

As a result, the timing of the controller's transmission of the status read command to the memory may affect the performance of the read, write, or erase operation on the memory.

### SUMMARY

Embodiments of the present disclosure provide a storage device and a method for operating the same, which enhance the performance of read operations by optimizing a transmission time interval of status read commands.

The objectives of the embodiments of the present disclosure are not limited to those set forth herein, and additional objectives will be apparent to one of ordinary skill in the art from the following description.

Embodiments of the disclosure may provide a storage device comprising a memory including a plurality of memory blocks and a cache caching data read from the plurality of memory blocks and a controller

configured to transmit a first read command to the memory, requesting to cache first data to the cache, when the memory is determined to be in an internal ready state; transmit a data output command to the memory, requesting to output the first data, when the memory is determined to be in an external ready state after transmitting the first read command; determine whether a second read command, requesting to cache second data to the cache, is present after receiving the first data output from the memory; and determine a transmission interval of a target status read command, which is a status read command for identifying a processing result of the second read command, differently based on whether the memory is in an internal busy state or the internal ready state when the second read command is present.

Embodiments of the disclosure may provide a method for operating a storage device, comprising, transmitting a first read command to a memory, including a cache for caching data read from a plurality of memory blocks, when the memory is determined to be in an internal ready state, the first read command requesting to cache first data in the cache; transmitting a data output command to the memory, requesting to output the first data, when the memory is determined to be in an external ready state after transmitting the first read command; receiving the first data output from the memory; determining whether a second read command, requesting to cache second data to the cache, is present after receiving the first data, and determining a transmission interval of a target status read command, which is a status read command for identifying a processing result of the second read command, differently based on whether the memory is in an internal busy state or the internal ready state when the second read command is present.

According to embodiments of the disclosure, there may be provided a storage device and an operation method thereof, which may enhance the performance of the read operation by adjusting the transmission time interval of status read commands.

The effects of the disclosure are not limited to the foregoing objects, and other effects will be apparent to one of ordinary skill in the art from the following detailed description.

### BRIEF DESCRIPTION OF THE DRAWINGS

The disclosure will be more fully understood from the following detailed description and the accompanying drawings, which are provided for illustration only and are not intended to limit the disclosure.

FIG. 1 is a schematic configuration diagram of a storage device according to an embodiment of the present disclosure.

FIG. 2 is a block diagram schematically illustrating a memory of FIG. 1.

FIG. 3 illustrates a schematic structure of a storage device according to an embodiment of the present disclosure.

FIG. 4 is a flowchart schematically illustrating operations of a storage device according to an embodiment of the present disclosure.

FIG. 5 is a flowchart illustrating an operation of determining whether a memory is in an internal busy state according to an embodiment of the present disclosure.

FIG. 6 is a flowchart illustrating an operation of determining whether a memory is in an external busy state according to an embodiment of the present disclosure.

FIG. 7 is a flowchart illustrating an operation in which a storage device determines a transmission interval of a target status read command according to an embodiment of the present disclosure.

FIG. 8 illustrates a difference between a first interval and a second interval according to an embodiment of the present disclosure.

FIG. 9 illustrates a method for operating a storage device according to an embodiment of the disclosure.

### DETAIL DESCRIPTION

Hereinafter, embodiments of the disclosure are described in detail with reference to the accompanying drawings. In assigning reference numerals to components of each drawing, the same components may be assigned the same numerals even when they are shown on different drawings. When determined to make the subject matter of the disclosure unclear, the detailed of the known art or functions may be skipped. As used herein, when a component “includes,” “has,” or “is composed of” another component, the component may add other components unless the component “only” includes, has, or is composed of” the other component. As used herein, the singular forms “a,” “an,” and “the” are intended to include the plural forms as well, unless the context clearly indicates otherwise.

Such denotations as “first,” “second,” “A,” “B,” “(a),” and “(b),” may be used in describing the components of the disclosure. These denotations are provided merely to distinguish a component from another, and the essence, order, or number of the components are not limited by the denotations.

In describing the positional relationship between components, when two or more components are described as “connected,” “coupled,” or “linked,” the two or more components may be directly “connected,” “coupled,” or “linked,” or another component may intervene. Here, the other component may be included in one or more of the two or more components that are “connected,” “coupled,” or “linked” to each other.

When such terms as, e.g., “after,” “next to,” “after,” and “before,” are used to describe the temporal flow relationship related to components, operation methods, and fabricating methods, it may include a non-continuous relationship unless the term “immediately” or “directly” is used.

When a component is designated with a value or its corresponding information (e.g., level), the value or the corresponding information may be interpreted as including a tolerance that may arise due to various factors (e.g., process factors, internal or external impacts, or noise).

Hereinafter, various embodiments of the present disclosure are described in detail with reference to the accompanying drawings.

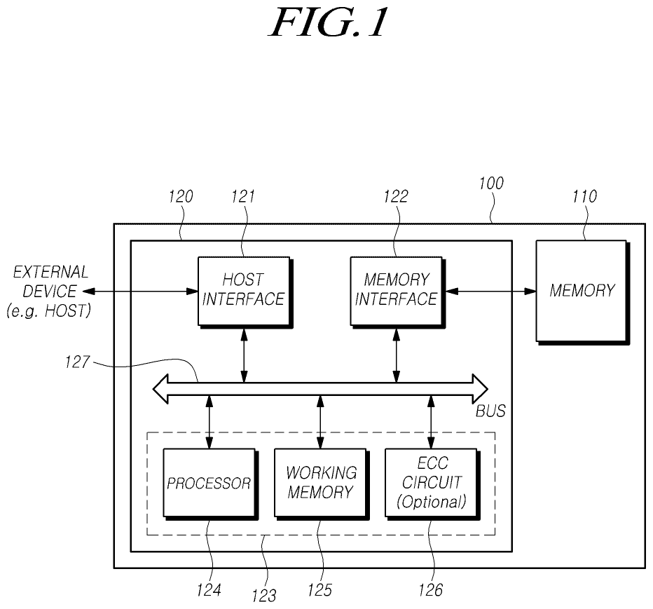

FIG. 1 is a schematic configuration diagram of a storage device 100 according to an embodiment of the disclosure.

Referring to FIG. 1, the storage device 100 may include a memory 110 that stores data and a controller 120 that controls the memory 110.

The memory 110 includes a plurality of memory blocks, and operates under the control of the controller 120. Operations of the memory 110 may include, for example, a read operation, a program operation (also referred to as a write operation) and an erase operation.

The memory 110 may include a memory cell array including a plurality of memory cells (also simply referred to as “cells”) that store data.

For example, the memory 110 may be realized in various types of memory such as a DDR SDRAM (double data rate synchronous dynamic random access memory), an LPDDR4 (low power double data rate 4) SDRAM, a GDDR (graphics double data rate) SDRAM, an LPDDR (low power DDR), an RDRAM (Rambus dynamic random access memory), a NAND flash memory, a 3D NAND flash memory, a NOR flash memory, a resistive random access memory (RRAM), a phase-change memory (PRAM), a magnetoresistive random access memory (MRAM), a ferroelectric random access memory (FRAM), a spin transfer torque random access memory (STT-RAM), and so forth.

The memory 110 may be implemented as a three-dimensional array structure. For example, embodiments of the present disclosure may be applied to a charge trap flash (CTF) in which a charge storage layer is configured by a dielectric layer and a flash memory in which a charge storage layer is configured by a conductive floating gate.

The memory 110 may receive a command and an address from the controller 120 and may access an area in the memory cell array that is selected by the address. In other words, the memory 110 may perform an operation indicated by the command, on the area selected by the address.

The memory 110 may perform a program operation, a read operation or an erase operation. For example, when performing the program operation, the memory 110 may program data to the area selected by the address. When performing the read operation, the memory 110 may read data from the area selected by the address. In the erase operation, the memory 110 may erase data stored in the area selected by the address.

The controller 120 may control write (or program), read, erase and background operations for the memory 110. For example, background operations may include at least one from among a garbage collection (GC) operation, a wear leveling (WL) operation, a read reclaim (RR) operation, a bad block management (BBM) operation, and so forth.

The controller 120 may control the operation of the memory 110 according to a request from a device (e.g., a host) located outside the storage device 100. The controller 120, however, also may control the operation of the memory 110 regardless of a request from the host.

The host may be a computer, an ultra-mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, an RFID (radio frequency identification) device, and a mobility device (e.g., a vehicle, a robot or a drone) capable of driving under human control or autonomous driving, as non-limiting examples. Alternatively, the host may be a virtual reality (VR) device providing 2D or 3D virtual reality images or an augmented reality (AR) device providing augmented reality images. The host may be any one of various electronic devices that require the storage device 100 capable of storing data.

The host may include at least one operating system (OS). The operating system may generally manage and control the function and operation of the host, and may control interoperability between the host and the storage device 100. The operating system may be classified into a general operating system and a mobile operating system depending on the mobility of the host.

The controller 120 and the host may be devices that are separated from each other, or the controller 120 and the host may be integrated into one device. Hereunder, for the sake of convenience in explanation, descriptions will describe the controller 120 and the host as devices that are separated from each other.

Referring to FIG. 1, the controller 120 may include a memory interface 122 and a control circuit 123, and may further include a host interface 121.

The host interface 121 provides an interface for communication with the host. For example, the host interface 121 provides an interface that uses at least one from among various interface protocols such as a USB (universal serial bus) protocol, an MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol, an IDE (integrated drive electronics) protocol and a private protocol.

When receiving a command from the host, the control circuit 123 may receive the command through the host interface 121, and may perform an operation of processing the received command.

The memory interface 122 may be coupled with the memory 110 to provide an interface for communication with the memory 110. That is to say, the memory interface 122 may be configured to provide an interface between the memory 110 and the controller 120 under the control of the control circuit 123.

The control circuit 123 performs the general control operations of the controller 120 to control the operation of the memory 110. To this end, for instance, the control circuit 123 may include at least one of a processor 124 and a working memory 125, and may optionally include an error detection and correction circuit (ECC circuit) 126.

The processor 124 may control general operations of the controller 120, and may perform a logic calculation. The processor 124 may communicate with the host through the host interface 121, and may communicate with the memory 110 through the memory interface 122.

The processor 124 may execute logical operations required to perform the function of a flash translation layer (FTL). The processor 124 may translate a logical block address (LBA), provided by the host, into a physical block address (PBA) through the flash translation layer. The flash translation layer may receive the logical block address and translate the logical block address into the physical block address, by using a mapping table.

There are various address mapping methods of the flash translation layer, depending on a mapping unit. Representative address mapping methods include a page mapping method, a block mapping method and a hybrid mapping method.

The processor 124 may randomize data received from the host. For example, the processor 124 may randomize data received from the host by using a set randomizing seed. The randomized data may be provided to the memory 110, and may be programmed to a memory cell array of the memory 110.

In a read operation, the processor 124 may derandomize data received from the memory 110. For example, the processor 124 may derandomize data received from the memory 110 by using a derandomizing seed. The derandomized data may be output to the host.

The processor 124 may execute firmware to control the operation of the controller 120. Namely, in order to control the general operation of the controller 120 and perform a logic calculation, the processor 124 may execute (or drive) firmware loaded in the working memory 125 upon booting. Hereafter, an operation of the storage device 100 according to embodiments of the disclosure will be described as implementing a processor 124 that executes firmware in which the corresponding operation is defined.

Firmware, as a program to be executed in the storage device 100 to drive the storage device 100, may include various functional layers. For example, the firmware may include binary data in which codes for executing the functional layers, respectively, are defined.

For example, the firmware may include at least one from among a flash translation layer, which performs a translating function between a logical address requested to the storage device 100 from the host and a physical address of the memory 110; a host interface layer (HIL), which serves to analyze a command requested to the storage device 100 as a storage device from the host and transfer the command to the flash translation layer; and a flash interface layer (FIL), which transfers a command, instructed from the flash translation layer, to the memory 110.

Such firmware may be loaded in the working memory 125 from, for example, the memory 110 or a separate nonvolatile memory (e.g., a ROM or a NOR Flash) located outside the memory 110. The processor 124 may first load all or a part of the firmware in the working memory 125 when executing a booting operation after power-on.

The processor 124 may perform a logic calculation, which is defined in the firmware loaded in the working memory 125, to control the general operation of the controller 120. The processor 124 may store a result of performing the logic calculation defined in the firmware, in the working memory 125. The processor 124 may control the controller 120 according to a result of performing the logic calculation defined in the firmware such that the controller 120 generates a command or a signal. When a part of firmware, in which a logic calculation to be performed is defined, is stored in the memory 110, but not loaded in the working memory 125, the processor 124 may generate an event (e.g., an interrupt) for loading the corresponding part of the firmware into the working memory 125 from the memory 110.

The processor 124 may load metadata necessary for driving firmware from the memory 110. The metadata, as data for managing the memory 110, may include for example management information on user data stored in the memory 110.

Firmware may be updated while the storage device 100 is manufactured or while the storage device 100 is operating. The controller 120 may download new firmware from the outside of the storage device 100 and update existing firmware with the new firmware.

To drive the controller 120, the working memory 125 may store necessary firmware, a program code, a command and data. The working memory 125 may be a volatile memory that includes, for example, at least one from among an SRAM (static RAM), a DRAM (dynamic RAM) and an SDRAM (synchronous DRAM). Meanwhile, the controller 120 may additionally use a separate volatile memory (e.g., SRAM, DRAM) located outside the controller 120 in addition to the working memory 125.

The error detection and correction circuit 126 may detect an error bit of target data, and correct the detected error bit by using an error correction code. The target data may be, for example, data stored in the working memory 125 or data read from the memory 110.

The error detection and correction circuit 126 may decode data by using an error correction code. The error detection and correction circuit 126 may be realized by various code decoders. For example, a decoder that performs unsystematic code decoding or a decoder that performs systematic code decoding may be used.

For example, the error detection and correction circuit 126 may detect an error bit by the unit of a set sector in each of the read data, when each read data is constituted by a plurality of sectors. A sector may mean a data unit that is smaller than a page, which is the read unit of a flash memory. Sectors constituting each read data may be matched with one another using an address.

The error detection and correction circuit 126 may calculate a bit error rate (BER), and may determine whether an error is correctable or not, by sector units. For example, when a bit error rate is higher than a reference value, the error detection and correction circuit 126 may determine that a corresponding sector is uncorrectable or has failed. On the other hand, when a bit error rate is lower than the reference value, the error detection and correction circuit 126 may determine that a corresponding sector is correctable or has passed.

The error detection and correction circuit 126 may perform an error detection and correction operation sequentially for all read data. In the case where a sector included in read data is correctable, the error detection and correction circuit 126 may omit an error detection and correction operation for a corresponding sector for next read data. If the error detection and correction operation for all read data is ended in this way, then the error detection and correction circuit 126 may detect a sector which is uncorrectable in read data last. There may be one or more sectors that are determined to be uncorrectable. The error detection and correction circuit 126 may transfer information (e.g., address information) regarding a sector which is determined to be uncorrectable to the processor 124.

A bus 127 may be configured to provide channels among the components 121, 122, 124, 125 and 126 of the controller 120. The bus 127 may include, for example, a control bus for transferring various control signals, commands and the like, a data bus for transferring various data, and so forth.

Some components among the above-described components 121, 122, 124, 125, and 126 of the controller 120 may be omitted, or some components among the above-described components 121, 122, 124, 125, and 126 of the controller 120 may be integrated into one component. In addition to the above-described components 121, 122, 124, 125, and 126 of the controller 120, one or more other components may be added.

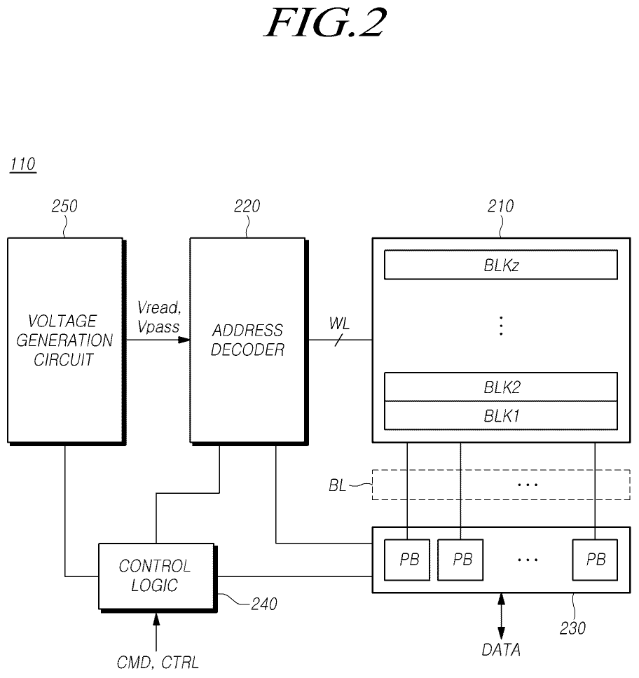

Hereinbelow, the memory 110 will be described in further detail with reference to FIG. 2.

FIG. 2 is a block diagram schematically illustrating the memory 110 of FIG. 1.

Referring to FIG. 2, the memory 110 may include a memory cell array 210, an address decoder 220, a read and write circuit 230, a control logic 240, and a voltage generation circuit 250.

The memory cell array 210 may include a plurality of memory blocks BLK1 to BLKz (where z is a natural number of 2 or greater).

In the plurality of memory blocks BLK1 to BLKz, a plurality of word lines WL and a plurality of bit lines BL may be disposed, and a plurality of memory cells may be arranged.

The plurality of memory blocks BLK1 to BLKz may be coupled with the address decoder 220 through the plurality of word lines WL. The plurality of memory blocks BLK1 to BLKz may be coupled with the read and write circuit 230 through the plurality of bit lines BL.

Each of the plurality of memory blocks BLK1 to BLKz may include a plurality of memory cells. For example, the plurality of memory cells may be nonvolatile memory cells, and may be configured by nonvolatile memory cells that have vertical channel structures.

The memory cell array 210 may be configured by a memory cell array of a two-dimensional structure or may be configured by a memory cell array of a three-dimensional structure.

Each of the plurality of memory cells included in the memory cell array 210 may store at least 1-bit data. For instance, each of the plurality of memory cells included in the memory cell array 210 may be a single level cell (SLC) that stores 1-bit data. In another instance, each of the plurality of memory cells included in the memory cell array 210 may be a multi-level cell (MLC) that stores 2-bit data. In still another instance, each of the plurality of memory cells included in the memory cell array 210 may be a triple level cell (TLC) that stores 3-bit data. In yet another instance, each of the plurality of memory cells included in the memory cell array 210 may be a quad level cell (QLC) that stores 4-bit data. In a further instance, the memory cell array 210 may include a plurality of memory cells, each of which stores 5 or more-bit data.

The number of bits of data stored in each of the plurality of memory cells may be dynamically determined. For example, a single-level cell that stores 1-bit data may be changed to a triple-level cell that stores 3-bit data.

Referring to FIG. 2, the address decoder 220, the read and write circuit 230, the control logic 240 and the voltage generation circuit 250 may operate as a peripheral circuit that drives the memory cell array 210.

The address decoder 220 may be coupled to the memory cell array 210 through the plurality of word lines WL.

The address decoder 220 may be configured to operate in response to the control of the control logic 240.

The address decoder 220 may receive an address through an input/output buffer in the memory 110. The address decoder 220 may be configured to decode a block address in the received address. The address decoder 220 may select at least one memory block depending on the decoded block address.

The address decoder 220 may receive a read voltage Vread and a pass voltage Vpass from the voltage generation circuit 250.

The address decoder 220 may apply the read voltage Vread to a selected word line WL in a selected memory block during a read operation, and may apply the pass voltage Vpass to the remaining unselected word lines WL.

The address decoder 220 may apply a verify voltage generated

in the voltage generation circuit 250 to a selected word line WL in a selected memory block in a program verify operation, and may apply the pass voltage Vpass to the remaining unselected word lines WL.

The address decoder 220 may be configured to decode a column address in the received address. The address decoder 220 may transmit the decoded column address to the read and write circuit 230.

A read operation and a program operation of the memory 110 may be performed by the unit of a page. An address received when a read operation or a program operation is requested may include at least one from among a block address, a row address and a column address.

The address decoder 220 may select one memory block and one word line depending on a block address and a row address. A column address may be decoded by the address decoder 220 and be provided to the read and write circuit 230.

The address decoder 220 may include at least one from among a block decoder, a row decoder, a column decoder and an address buffer.

The read and write circuit 230 may include a plurality of page buffers PB. The read and write circuit 230 may operate as a read circuit in a read operation of the memory cell array 210, and may operate as a write circuit in a write operation of the memory cell array 210.

The read and write circuit 230 described above may also be referred to as a page buffer circuit or a data register circuit that includes a plurality of page buffers PB. The read and write circuit 230 may include data buffers that take charge of a data processing function, and may further include cache buffers that take charge of a caching function.

The plurality of page buffers PB may be coupled to the memory cell array 210 through the plurality of bit lines BL. The plurality of page buffers PB may continuously supply sensing current to bit lines BL coupled with memory cells to sense threshold voltages (Vth) of the memory cells in a read operation and a program verify operation, and may latch sensing data by sensing, through sensing nodes, changes in the amounts of current flowing, depending on the programmed states of the corresponding memory cells.

The read and write circuit 230 may operate in response to page buffer control signals output from the control logic 240.

In a read operation, the read and write circuit 230 temporarily stores read data by sensing data of memory cells, and then, outputs data DATA to the input/output buffer of the memory 110. As an exemplary embodiment, the read and write circuit 230 may include a column select circuit in addition to the page buffers PB or the page registers.

The control logic 240 may be coupled with the address decoder 220, the read and write circuit 230 and the voltage generation circuit 250.

The control logic 240 may receive a command CMD and a control signal CTRL through the input/output buffer of the memory 110. The control logic 240 may be configured to control general operations of the memory 110 in response to the control signal CTRL. The control logic 240 may output control signals for adjusting the precharge potential levels of the sensing nodes of the plurality of page buffers PB.

The control logic 240 may control the read and write circuit 230 to perform a read operation of the memory cell array 210. The voltage generation circuit 250 may generate the read voltage Vread and the pass voltage Vpass used in a read operation, in response to a voltage generation circuit control signal output from the control logic 240.

Each memory block of the memory 110 described above may be configured by a plurality of pages corresponding to a plurality of word lines WL and a plurality of strings corresponding to a plurality of bit lines BL.

In a memory block BLK, a plurality of word lines WL and a plurality of bit lines BL may be disposed to intersect with each other. For example, each of the plurality of word lines WL may be disposed in a row direction, and each of the plurality of bit lines BL may be disposed in a column direction. In another example, each of the plurality of word lines WL may be disposed in a column direction, and each of the plurality of bit lines BL may be disposed in a row direction.

A memory cell may be coupled to one of the plurality of word lines WL and one of the plurality of bit lines BL. A transistor may be disposed in each memory cell.

For example, a transistor disposed in each memory cell may include a drain, a source, and a gate. The drain (or source) of the transistor may be coupled with a corresponding bit line BL directly or via another transistor. The source (or drain) of the transistor may be coupled with a source line (which may be the ground) directly or via another transistor. The gate of the transistor may include a floating gate, which is surrounded by a dielectric, and a control gate to which a gate voltage is applied from a word line WL.

In each memory block, a first select line (also referred to as a source select line or a drain select line) may be additionally disposed outside a first outermost word line more adjacent to the read and write circuit 230 between two outermost word lines, and a second select line (also referred to as a drain select line or a source select line) may be additionally disposed outside a second outermost word line between the two outermost word lines.

At least one dummy word line may be additionally disposed between the first outermost word line and the first select line. At least one dummy word line may also be additionally disposed between the second outermost word line and the second select line.

A read operation and a program operation (or write operation) of the memory block described above may be performed by the unit of a page, and an erase operation may be performed by the unit of a memory block.

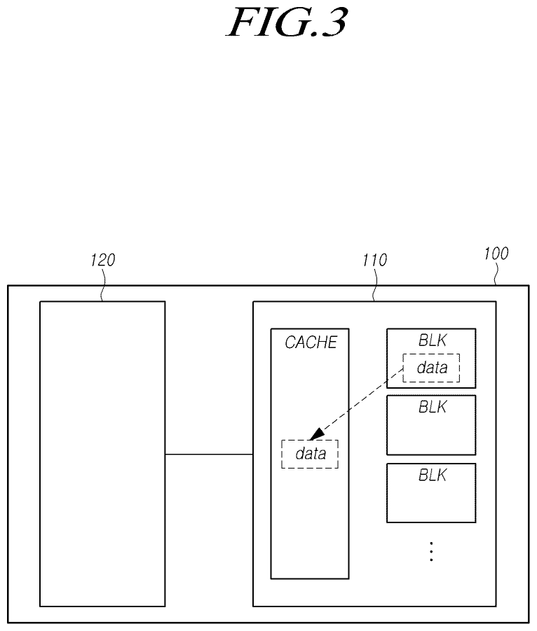

FIG. 3 illustrates a schematic structure of a storage device 100 according to an embodiment of the present disclosure.

Referring to FIG. 3, the storage device 100 may include a memory 110 and a controller 120.

The memory 110 may include a plurality of memory blocks BLK and a cache CACHE. The cache CACHE may temporarily store data read from the plurality of memory blocks BLK. Data stored in the plurality of memory blocks BLK may be cached in the cache CACHE before being output to the controller 120.

For example, the cache CACHE may be implemented as the above-described page buffer. As another example, the cache CACHE may be implemented as a separate volatile memory.

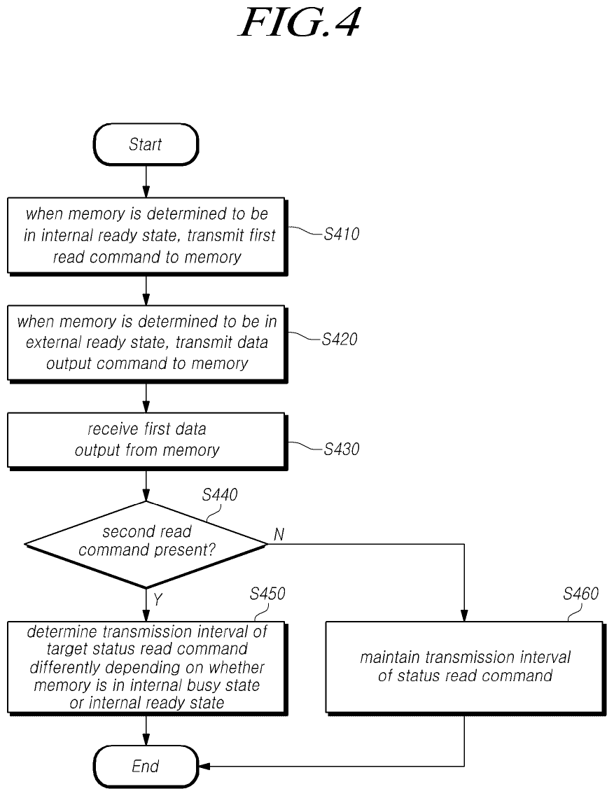

The controller 120 may transmit a read command to the memory 110, requesting that data be cached in the cache CACHE. Further, the controller 120 may transmit a data output command to the memory 110, requesting to output the data stored in the cache CACHE. This process is described in detail below with reference to FIG. 4.

FIG. 4 is a flowchart schematically illustrating operations of a storage device 100 according to an embodiment of the present disclosure. The operations are described with reference to FIG. 3.

Referring to FIGS. 3 and 4, when it is determined that the memory 110 is in an internal ready state, the controller 120 of the storage device 100 may transmit a first read command to the memory 110, requesting that first data be cached in the cache CACHE (S410).

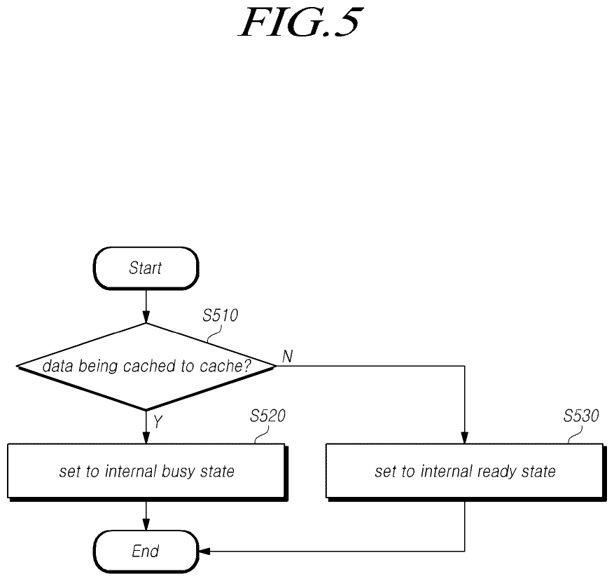

In this case, the memory 110 may be set to either an internal busy state or an internal ready state, depending on whether data is being cached in the cache CACHE. This process is described in detail below with reference to FIG. 5.

In this case, the controller 120 may determine whether the memory 110 is in the internal ready state as follows.

For example, the controller 120 may transmit a status read command to the memory 110, receive a response to the status read command from the memory 110, and determine whether the memory 110 is in the internal ready state based on an internal busy bit included in the response.

The controller 120 may determine that the memory 110 is in the internal busy state if the internal busy bit has a first value (e.g., 1) and may determine that the memory 110 is in the internal ready state if the internal busy bit has a second value (e.g., 0).

In step S410, after transmitting the first read command to the memory 110, if it is determined that the memory 110 is in an external ready state, the controller 120 may transmit a data output command to the memory 110, requesting to output the first data (S420).

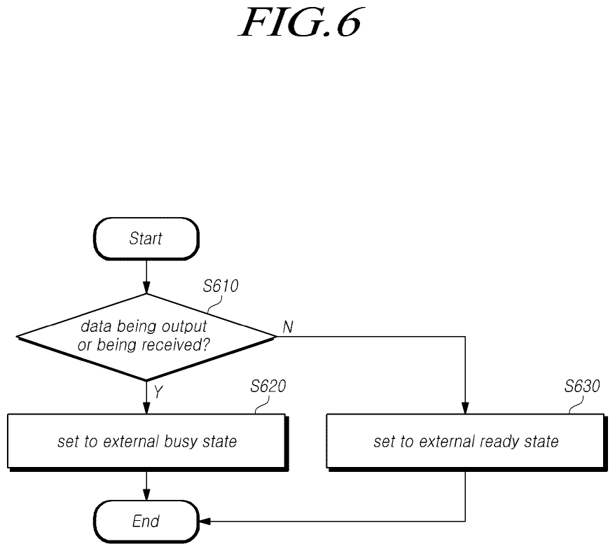

In this case, the memory 110 may be set to either an external busy state or the external ready state, depending on whether data is being output or received. This process is described in detail below with reference to FIG. 6.

In this case, the controller 120 may determine whether the memory 110 is in the external ready state as follows.

For example, the controller 120 may transmit a status read command to the memory 110, receive a response to the status read command, and determine whether the memory 110 is in the external ready state based on an external busy bit included in the response.

The controller 120 may determine that the memory 110 is in the external busy state if the external busy bit has a first value (e.g., 1) and may determine that the memory 110 is in the external ready state if the external busy bit has a second value (e.g., 0).

In step S420, after transmitting the data output command to the memory 110, the controller 120 may receive the first data output from the memory 110 (S430).

Thereafter, the controller 120 may determine whether there is a second read command requesting that second data be cached in the cache (S440). If there is the second read command that has not yet been transmitted to the memory 110, the controller 120 may store the second read command in the inside, e.g., in a working memory of the controller 120.

If the second read command is present (S440—Y), the controller 120 may differently determine a transmission interval of a target status read command based on whether the memory 110 is in the internal busy state or the internal ready state (S450). In this case, the target status read command is a status read command for identifying the processing result of the second read command.

When the second read command is present, the controller 120 may transmit the second read command to the memory 110 before transmitting the target status read command to the memory 110.

On the other hand, if the second read command is not present (S440—N), the controller 120 may keep the transmission interval of the target status read command unchanged (S460).

FIG. 5 is a flowchart illustrating an operation of determining whether the memory 110 is in the internal busy state according to an embodiment of the present disclosure.

Referring to FIG. 5, the memory 110 determines whether data is being cached to the cache CACHE from one or more of a plurality of memory blocks BLK (S510).

When data is being cached to the cache CACHE from one or more of the memory blocks BLK (S510—Y), the memory 110 may be set to the internal busy state (S520).

On the other hand, when no data is being cached to the cache CACHE from the plurality of memory blocks BLK (S510—N), the memory 110 may be set to the internal ready state (S530).

FIG. 6 is a flowchart illustrating an operation of determining whether the memory 110 is in the external busy state according to an embodiment of the present disclosure.

Referring to FIG. 6, the memory 110 determines whether data is being output to the controller 120 or received from the controller 120 (S610).

When data is being output to the controller 120 or input from the controller 120 (S610—Y), the memory 110 may be set to the external busy state (S620).

On the other hand, when no data is output to the controller 120 and input from the controller 120 (S610—N), the memory 110 may be set to the external ready state (S630).

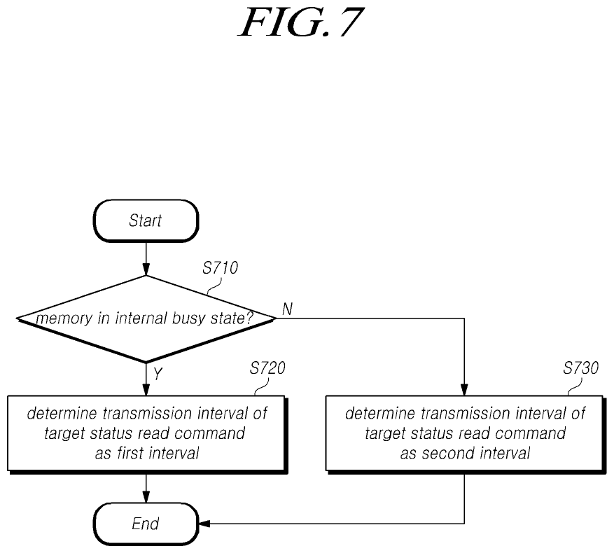

FIG. 7 is a flowchart illustrating an operation in which the storage device 100 determines the transmission interval of the target status read command according to an embodiment of the present disclosure.

Referring to FIG. 7, the controller 120 of the storage device 100 determines whether the memory 110 is in the internal busy state (S710). As described above, the controller 120 may determine whether the memory 110 is in the internal busy state based on a status read command.

When the memory 110 is in the internal busy state (S710—Y), the controller 120 may determine the transmission interval of the target status read command as a first interval (S720).

On the other hand, when the memory 110 is in the internal ready state (S710—N), the controller 120 may determine the transmission interval of the target status read command as a second interval (S730).

In embodiments according to the present disclosure, the controller 120 may transmit the target status read command to the memory 110 after a set transmission interval (e.g., the first interval or the second interval) has elapsed from a reference time.

For example, the reference time may be a time at which the controller 120 transmits the second read command to the memory 110.

As another example, the reference time may be a time at which the controller 120 transmits another status read command to the memory 110.

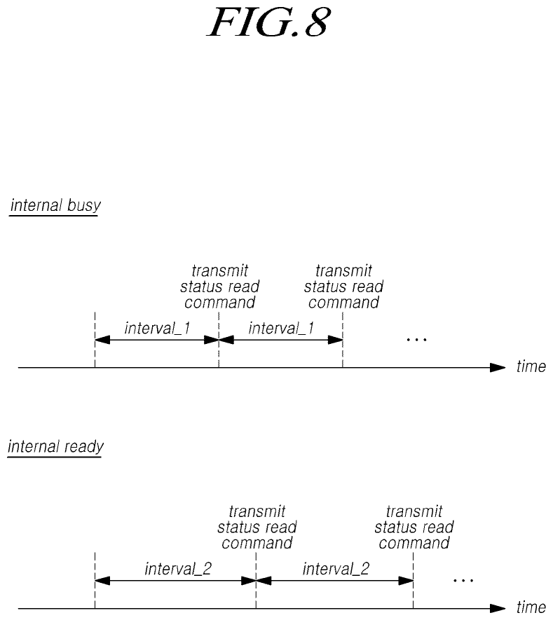

FIG. 8 illustrates a difference between the first interval and the second interval according to an embodiment of the present disclosure.

Referring to FIG. 8, when the memory 110 is in the internal busy state, the controller 120 may determine the transmission interval of the target status read command as the first interval. In other words, the controller 120 may periodically transmit the target status read command at the first interval until the processing of the second read command is completed.

On the other hand, when the memory 110 is in the internal ready state, the controller 120 may determine the transmission interval of the target status read command as the second interval. In other words, the controller 120 may periodically transmit the target status read command at the second interval until the processing of the second read command is completed.

In this case, the second interval may be longer than the first interval.

The controller 120 determines the transmission interval of the target status read command differently depending on whether the memory 110 is in the internal ready state or the internal busy state for the following reason.

When the memory 110 is in the internal busy state when the second read command is transmitted, the operation of discharging and precharging a word line in the process of caching the second data requested by the second read command into the cache CACHE may be omitted. As a result, the second data can be cached more quickly to the cache CACHE. Consequently, the controller 120 may reduce the transmission interval of the target status read command in order to more quickly identify the processing result of the second read command, based on the time when the second data is cached to the cache CACHE.

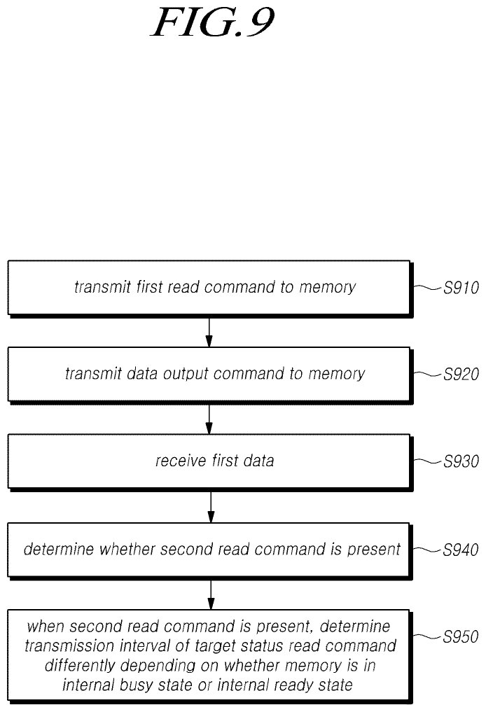

FIG. 9 illustrates a method for operating a storage device 100 according to the disclosure. The method of FIG. 9 is described with reference to FIG. 3. The method may be performed by the controller 120.

Referring to FIGS. 3 and 9, the method for operating the storage device 100 may include transmitting, to the memory 110, a first read command requesting that first data be cached to the cache CACHE included in the memory 110 when it is determined that the memory 110 is in the internal ready state (S910).

For example, step S910 may determine that the memory 110 is in the internal busy state when data is being cached from one or more of the plurality of memory blocks BLK included in the memory 110 to the cache CACHE, and, when there is no data being cached from the plurality of memory blocks BLK to the cache CACHE, determine that the memory 110 is in the internal ready state.

The operation method of the storage device 100 may include, when the memory 110 is determined to be in the external ready state after transmitting the first read command to the memory 110, transmitting, to the memory 110, a data output command requesting to output the first data (S920).

For example, step S920 may determine that the memory 110 is in the external busy state when the memory 110 is outputting data or receiving data, and, when the memory 110 does not output data and does not receive data, determine that the memory 110 is in the external ready state.

The operation method of the storage device 100 may include receiving the first data output from the memory 110 (S930).

The operation method of the storage device 100 may include, after receiving the first data, determining whether there is a second read command requesting to cache second data to the cache CACHE (S940).

The operation method of the storage device 100 may include, when the second read command is present, determining the transmission interval of the target status read command, which is a status read command for identifying the processing result of the second read command, differently depending on whether the memory 110 is in the internal busy state or the internal ready state (S950).

For example, step S950 may determine the transmission interval of the target status read command as the first interval when the memory 110 is in the internal busy state, and, when the memory 110 is in the internal ready state, determine the transmission interval of the target status read command as the second interval. In this case, the second interval may be longer than the first interval.

Although exemplary embodiments of the disclosure have been described for illustrative purposes, those skilled in the art will appreciate that various modifications, additions and substitutions are possible, without departing from the scope and spirit of the disclosure. Therefore, the embodiments disclosed above and in the accompanying drawings should be considered in a descriptive sense only and not for limiting the technological scope. The technological scope of the disclosure is not limited by the embodiments and the accompanying drawings. The spirit and scope of the disclosure should be interpreted in connection with the appended claims and encompass all equivalents falling within the scope of the appended claims.

What is claimed is:

1. A storage device, comprising:
a memory including a plurality of memory blocks and a cache for caching data read from the plurality of memory blocks; and
a controller configured to:
transmit a first read command to the memory, requesting to cache first data to the cache, when the memory is determined to be in an internal ready state;
transmit a data output command to the memory, requesting to output the first data, when the memory is determined to be in an external ready state after transmitting the first read command;
determine whether a second read command, requesting to cache second data to the cache, is present after receiving the first data output from the memory; and
determine a transmission interval of a target status read command, which is a status read command for identifying a processing result of the second read command, differently based on whether the memory is in an internal busy state or the internal ready state when the second read command is present.

2. The storage device of claim 1, wherein the memory is set to the internal busy state when data is being cached from one or more of the plurality of memory blocks to the cache, and is set to the internal ready state when no data is being cached from the plurality of memory blocks to the cache.

3. The storage device of claim 1, wherein the controller is further configured to:
transmit a status read command to the memory; and
determine whether the memory is in the internal ready state based on an internal busy bit included in a response to the status read command.

4. The storage device of claim 1, wherein the memory is set to an external busy state when data is being output to the controller or received from the controller, and is set to the external ready state when data is neither being output to the controller nor received from the controller.

5. The storage device of claim 4, wherein the controller is further configured to:
transmit a status read command to the memory; and
determine whether the memory is in the external ready state based on an external busy bit included in a response to the status read command.

6. The storage device of claim 1, wherein the controller is configured to:
determine the transmission interval of the target status read command as a first interval when the memory is in the internal busy state; and
determine the transmission interval of the target status read command as a second interval when the memory is in the internal ready state.

7. The storage device of claim 6, wherein the second interval is longer than the first interval.

8. A method for operating a storage device, the method comprising:
transmitting a first read command to a memory, including a cache for caching data read from a plurality of memory blocks, when the memory is determined to be in an internal ready state, the first read command requesting to cache first data in the cache;
transmitting a data output command to the memory, requesting to output the first data, when the memory is determined to be in an external ready state after transmitting the first read command;
receiving the first data output from the memory;
determining whether a second read command, requesting to cache second data to the cache, is present after receiving the first data; and
determining a transmission interval of a target status read command, which is a status read command for identifying a processing result of the second read command, differently based on whether the memory is in an internal busy state or the internal ready state when the second read command is present.

9. The method of claim 8, wherein transmitting the first read command to the memory includes:
determining that the memory is in the internal busy state when data is being cached from one or more of the plurality of memory blocks to the cache; and
determining that the memory is in the internal ready state when no data is being cached from the plurality of memory blocks to the cache.

10. The method of claim 8, wherein transmitting the data output command to the memory includes:
determining that the memory is in an external busy state when the memory is outputting data or receiving data; and
determining that the memory is in an external ready state when the memory is neither outputting data nor receiving data.

11. The method of claim 8, wherein determining the transmission interval of the target status read command includes:
determining the transmission interval of the target status read command as a first interval when the memory is in the internal busy state; and
determining the transmission interval of the target status read command as a second interval when the memory is in the internal ready state.

12. The method of claim 11, wherein the second interval is longer than the first interval.
